(19) United States
(12) Patent Application Publication
(10) Pub. No.: US 2026/0350759 A1
(43) Pub. Date: Nov. 5, 2026

(54) REDUCING A NOISE IN A SEQUENTIAL IMAGE RECORDING

(71) Applicant: Siemens Healthineers AG, Forchheim (DE)

(72) Inventors: Felix Denzinger, Herzogenaurach (DE); Philipp Roser, Allston, MA (US)

(21) Appl. No.: 19/666,253

(22) Filed: May 2, 2026

(30) Foreign Application Priority Data
May 2, 2025 (DE) 10 2025 116 888.1

(51) Int. Cl. G06T 5/70; G06T 5/50; G06T 5/60

(52) U.S. Cl. CPC G06T 5/70; G06T 5/50; G06T 5/60; G06T 2207/10016; G06T 2207/10121; G06T 2207/20081; G06T 2207/20084; G06T 2207/20182; G06T 2207/20216

(57) ABSTRACT

A computer-implemented method for reducing a noise in an individual image that is to be improved of a temporal sequence of images of a sequential image recording of individual images that map an at least partially common examination region of an examination object includes receiving a series of preceding individual images that have been recorded temporally before the individual image to be improved and that are a portion of the sequence of images. The computer-implemented method includes applying a prediction algorithm to the series of preceding individual images. The prediction algorithm provides at least one synthetic prediction individual image as output data. The method includes receiving the individual image to be improved and applying a reducing algorithm to the individual image to be improved and to the at least one synthetic prediction individual image in order to provide a noise-reduced individual image.

This application claims the benefit of German Patent Application No. DE 10 2025 116 888.1, filed on May 2, 2025, which is hereby incorporated by reference in its entirety.

### BACKGROUND

The present embodiments relate to a computer-implemented method for reducing a noise in an individual image that is to be improved of a temporal sequence of images of a sequential image recording, a computer-implemented method for recording and displaying a temporal sequence of images of a sequential image recording, a computer-implemented method for providing a trained model, a provision unit, an imaging system, and a computer program product or computer-readable storage medium.

Fluoroscopy refers to a continuous image acquisition and/or image representation based on X-ray radiation. Fluoroscopy may also be referred to as transirradiation. Fluoroscopy may be used to observe processes continuously in the human or animal body. In order therein to keep the radiation burden on a patient as low as possible and to be able to reduce the applied radiation dose as far as possible, the attempt may be made, with the lowest possible dose, to keep a noise of individual images of an image series, also referred to as “frames,” as low as possible by forming mean values from preceding individual images. For example, static image portions may be more severely averaged while rapidly changing structures are regarded as essential information. This is also referred to as temporal averaging, and it functions well for relatively static scenes. In significantly movement-laden and/or dynamic scenarios (e.g., for applications in the heart or abdomen), artifacts may arise, however, through overlaid breathing movements or gut movements as a result of temporal averaging. Since fluoroscopy may be applied in real time, a more precise but more computation-intensive retrospective image correction may also not be practicable.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a possibility for better reducing an image noise in a, for example, X-ray-based sequential image recording, such as during a fluoroscopy (e.g., in non-static and/or dynamic scenarios) is provided.

In the following, the solutions according to the present embodiments are described in relation to methods and system, and in relation to the other aspects of the present embodiments. Features, advantages, or alternatives and embodiments that are able to be combined and are described in relation to one of the aspects may be attributed to the respective other aspects of the present embodiments and vice versa. For example, embodiments of the system may be improved with features that are described in the context of one or both of the methods, and vice versa. Functional features of the method are implemented via physical units or apparatuses of the system.

Further, the solution according to the present embodiments is described in relation to methods and systems for automatic performance of at least one object on images and/or image data, and in relation to methods and systems for the provision of a trained model based on machine learning. Features, advantages, and alternative or combinable embodiments may be attributed to the respective other aspects and vice versa. In other words, it is possible to improve embodiments for providing a trained model with features that are described in the context of the automatic performance of at least one object on images and/or image data. For example, datasets and/or images that are used in the methods and systems for automated performance of at least one object on images may have the same properties and features as the corresponding datasets and/or images that are used in the methods and systems for providing a trained model, and the trained models based on machine learning that are provided via the corresponding methods and systems, may be used in the methods and systems for automated performance of at least one object on image data and/or images.

According to a first aspect of the present embodiments, a computer-implemented method is provided for reducing a noise in an individual image that is to be improved of a temporal sequence of images of a, for example, X-ray-based sequential image recording (e.g., a fluoroscopy recording) of individual images that map an at least partially common examination region of an examination object. The method includes the following acts: receiving a series of preceding individual images that have been recorded temporally before the individual image to be improved and that are a portion of the sequence of images; applying a prediction algorithm, for example, including a trained model based on machine learning, to the series of preceding individual images, where the prediction algorithm is configured to predict, based on a series of preceding individual images, at least one synthetic individual image for a time point of the recording of the individual image to be improved, and where the prediction algorithm provides at least one synthetic prediction individual image as output data; receiving the individual image to be improved; applying a reducing algorithm to the individual image to be improved and to the at least one synthetic prediction individual image in order to provide a noise-reduced individual image based on the at least one synthetic prediction individual image and the individual image to be improved.

Therefore, via this method, the approach, based on the preceding individual images, of reducing a noise in a subsequent individual image is followed. In that the preceding individual images are used to predict a synthetic individual image, the available information of the preceding individual images may be utilized to achieve particularly good results. For example, in contrast to a simple averaging of the individual image to be improved with prior images, the occurrence of artifacts due to dynamic changes in the images may thus be counteracted. For example, it may thus be provided to predict movements and/or changes in the image and thus to generate a more accurate result for the noise-reduced individual image that contains, for example, fewer movement artifacts. The method may be provided for X-ray radiation-based sequential (e.g., continuous) image recordings (e.g., on living organisms and/or on humans, such as patients). In order to keep the radiation dose low, it is desirable to keep the radiation intensity as low as possible, although this typically leads to a lower signal-to-noise ratio. With the method according to the present embodiments, a noise may be reduced particularly well (e.g., also in dynamic recordings). The method is well suited to application in a fluoroscopy, which may also be referred to as transirradiation. For example, it has been found that the method may be carried out effectively in real time during a fluoroscopy, and thus, an effective noise reduction may be carried out during a real time observation, for example, of processes in the human body. This method is therefore advantageous as compared with known methods for noise reduction that contain a significantly greater computation effort and are therefore practically effectively unusable in real time during a fluoroscopy recording.

The sequential image recording may, in general, be recorded with any imaging device and/or may be based on any imaging modality that is suitable for recording successive and/or sequential images. The image recording may be based on a scan from a medical imaging modality. For example, the image recording may be based on a magnetic resonance tomography scan, an ultrasonic scan, an X-ray-based scan, or another scan. For example, the image recording may be an X-ray-based image recording. An X-ray-based image recording may be understood, in general, to be an image recording made on the basis that a body to be examined (e.g., a body of a patient) is transirradiated using an X-ray source, and that images are generated based on detected rays that have, for example, penetrated the body. The rays may traditionally be generated, for example, with a fluorescent screen. However, it is also possible in fluoroscopy to detect the X-rays with an X-ray detector (e.g., a flat detector) and then to display the detected X-rays on a screen. Therein, the images represented may then be processed in analogue and/or digital manner in that, for example, an X-ray image amplification is applied. In the context of the present embodiments, a corresponding processing via the computer-implemented method is provided.

In the context of the present embodiments, a temporal sequence of images of a sequential image recording may be a sequence of images that have been recorded temporally one after another (e.g., at regular or irregular spacings). The sequential image recording may be, for example, a continuous image recording. In the context of the present embodiments, a sequence of images of a sequential image recording may be a sequence of images that are recorded with a small temporal spacing. For example, the sequence of images is suitable for representing a quasi-continuous image and/or a moving image. The images are recorded at an image rate that has been set. The image rate may also be designated the image frequency or image refresh frequency. The image rate may be given in hertz (Hz) or in images per second, where the term frames per second (fps) may be used. For example, the sequence of images may be a sequence of images from a fluoroscopy recording. For example, the sequence of images may be provided with an image rate of from 2 to 100 (e.g., from 2 to 60 frames per second). The image rate may be dependent upon the respective application (e.g., the expected movement). By way of example, in some applications, an image rate may be in the range of 4 to 30 frames per second. For example, a fluoroscopy image rate for an observation of the heart may tend to be higher (e.g., up to 60 frames per second).

Both the individual image to be improved and also the preceding individual images are part of the sequence of images. The preceding individual images are, for example, individual images that are and/or have been recorded before the individual image to be improved. The preceding individual images may be received at once or temporally offset from one another. Similarly, the individual image to be improved may be received together with the preceding individual images or temporally offset therefrom (e.g., temporally thereafter). The individual image to be improved may be received, for example, during or after the application of the prediction algorithm. It may be provided, for example, that the preceding individual images are received at least partially or entirely before the individual image to be improved has been recorded or while the individual image to be improved is being recorded. For example, it may be provided that the preceding individual images and/or the individual image to be improved are each received temporally immediately following their recording time point. For example, it may be provided to apply the method sequentially repeatedly, so that a respective current individual image is initially the individual image to be improved and thereafter is part of the series of preceding individual images for a later individual image that is to be improved. Optionally, the preceding individual images may themselves at least partially be noise-reduced individual images (e.g., noise-reduced in accordance with the method according to the present embodiments). Alternatively, it may be provided that the preceding individual images or at least some of the preceding individual images are not noise-reduced.

For example, the series of preceding individual images may include at least three (e.g., at least four) preceding individual images. For example, it may be provided that the series of individual images includes four to ten preceding individual images. It may be provided that the series of individual images includes all the preceding individual images recorded in a current sequential (e.g., continuous) image recording. The series of preceding individual images may include, for example, those preceding individual images that were recorded immediately before the individual image that is to be improved. The number of individual images may be selected according to what is observed (e.g., which dynamic changes are to be expected and/or which image rate is used). It may be useful to delimit the image rate and/or the number of the preceding individual images in order to delimit the requirements on the computation power needed. Against this background, the delimitation to a maximum of 10 preceding individual images is favorable in order to combine a good quality with a sufficiently low computation effort. However, more preceding individual images may also be provided, for example, if a greater computation capacity is available.

A prediction algorithm is applied to the series of preceding individual images in order to generate at least one synthetic prediction individual image. For this purpose, the prediction algorithm is configured to predict, based on a series of preceding individual images, at least one synthetic individual image for a time point of the recording of the individual image to be improved. The preceding individual images are used as input for the prediction algorithm. The prediction individual image represents an estimate that is to be seen for a time point of the individual image to be improved (e.g., after the series of preceding individual images). The at least one prediction individual image does not have to correspond exactly to the individual image to be improved. For example, the prediction individual image may have an improved image quality or a lower noise than the individual image to be improved. However, the prediction individual image may possibly also be advantageous if the prediction individual image fundamentally has a similar quality and/or a similarly severe noise level as the individual image to be improved or even a somewhat lower quality. For example, from at least two (e.g., randomly distributed) noise-laden individual images that show fundamentally the same object, in the next step by way of averaging, an image with lower noise may be generated. The prediction individual image is synthetic in the sense that the prediction individual image is artificially generated by the prediction algorithm (e.g., does not arise directly from a real measurement). The prediction algorithm may optionally include an analytical model for predicting the synthetic prediction individual image. Optionally, the prediction algorithm may be configured, for example, with the aid of an interpolation starting from the preceding individual images, to generate the prediction individual image. In one embodiment, the prediction algorithm includes a trained model based on machine learning. The synthetic prediction individual image is generated, for example, with the aid of the trained model. It has been found that with a model trained based on machine learning, particularly good results may be achieved, both for the generation of a realistic prediction individual image and also specifically for the purpose of noise reduction.

The trained model may be carried out, for example, on a computer unit (e.g., a CPU or a GPU). In general, a trained model based on machine learning may be understood such that the trained model imitates cognitive functions that are generally associated with human understanding. For example, a model based on machine learning is capable, via training based on training data, of adapting itself to particular and/or new circumstances and to recognize and extrapolate patterns. In this case, therefore, the prediction individual image may be predicted starting from the preceding individual images. A trained model based on machine learning may also be referred to as a trained function or a trained algorithm. In general, parameters of the model based on machine learning may be adapted by training. The training may be, for example, supervised learning, semi-supervised learning, active learning, self-supervised learning, unsupervised learning, and/or reinforcement learning. For example, the parameters of the model may be adapted iteratively via a plurality of training steps. For example, during the training, a particular loss function may be optimized (e.g., minimized). For example, the trained model may include an artificial neural network, vision transformer, or a (e.g., stable) diffusion model. In addition or alternatively, the algorithm may be based on a k-means algorithm, a Q-learning, an evolutionary algorithm, and/or an association analysis. In the context of the training of a neural network, a back-propagation algorithm or error back-propagation algorithm may be used. The preceding individual images may be input, for example, as embedding or as pure images into the trained model.

A neural network may be, for example, a deep neural network (DNN) and/or a convolutional network. A convolutional network, also referred to as a convolutional neural network or CNN, optionally configured as a convolutional deep neural network, is a neural network that has a convolution operation in place of a general matrix multiplication in at least one of its layers (e.g., the “convolutional layer”). For example, a convolutional layer carries out a dot product (also referred to as a scalar product) of one or more convolutional kernels (also convolution matrix) with the input data and/or input image data (e.g., the preceding individual images of the convolutional layer). Therein, the entries of the one or the plurality of convolutional kernels are the parameters or weights that are adapted through the training. For example, a Frobenius scalar product and a rectified linear unit may be used. A rectified linear unit may be designated a ReLU activation function (from Rectified Linear Units). A convolutional network may have additional layers (e.g., a pooling layer, a fully-connected layer, and normalization layers). Via a convolutional network, image data may be processed particularly efficiently, for example, since a convolution operation based on different convolutional kernels may extract different image features; by adapting the weights of the convolutional kernel during training, the relevant image information may thus be found. Further, due to the shared weights in the convolutional kernels, fewer parameters may need to be trained, so that an overfitting during training may be prevented. A more rapid training or more layers of the network may be enabled, which may improve the performance of the network. For example, the trained adaptation model may be based on a U-Net architecture. The principles of a U-Net architecture are described by Ronneberger et al. in “U-Net: Convolutional Networks for Biomedical Image Segmentation”, arXiv: 1505.04597v1 [cs. CV] May 18, 2015. The network architecture of a U-Net typically includes a contracting path and an expanding path. The contracting path follows the typical architecture of a convolutional network. It may have repeated application of two 3×3 convolutions, each followed by a rectified linear unit (ReLU) and a max pooling or an average pooling operator (e.g., a 2×2 max pooling operation) and downsampling. With the pooling between the levels, the image size and/or resolution is reduced. With each downsampling step, the number of feature channels (or “feature maps”) is doubled. Each step in the expanded path may consist of an upsampling followed by a convolution (e.g., a 2×2 convolution) that halves the number of feature channels, a concatenation with the corresponding feature channels from the contraction path, and one or more further convolutions (e.g., two 3×3 convolutions), each followed by a ReLU. In the last step, a 1×1 convolution may be used to map each feature vector to the desired number of classes. For the purposes of the present embodiments, the known U-Net may be adapted, for example, such that the U-Net architecture has 5 levels, each with 2 convolutional layers with 3×3 convolutional kernels and a ReLU activation function. In each level, the number of feature channels is doubled, for example, so that in the first level, there are 64 channels, in the second level 128 channels, etc.

Alternatively, a different neural network (e.g., a convolutional network) may be used. For example, the neural network may be an adversarial network, a deep adversarial network, and/or a generative adversarial network (GAN) or generative adversarial neural network. A generative adversarial neural network (GAN) (e.g., a conditional GAN) may be advantageous to enable a natural training metric. Therein, a network (e.g., the discriminator) that learns whether an image in the target domain has been artificially generated (in this case, as a synthetic prediction individual image) or as a real image of the target domain is trained. This network may be used as a cost function for a second network (e.g., the generator) in order to learn the domain transfer. Both networks may be trained iteratively one after the other, and finally, the generator may be used to perform the domain transfer. For example, a network architecture that is described by Mehdi Mirza and Simon Osindero in arXiv:1411.1784 “Conditional Generative Adversarial Nets” may be used. A transformer-based network (e.g., a vision transformer-based network) may be advantageous with relatively large data quantities available for training. An example of a suitable network architecture for a transformer-based network is to be found in “StyTr²: Image Style Transfer with Transformers” by Yingying Deng et al. in Proceedings of the IEEE/CVF Conference on Computer Vision and Pattern Recognition (CVPR), 2022, pp. 11326-11336.

The individual image to be improved and the at least one synthetic prediction individual image are input into a reducing algorithm that is configured, with this input, to reduce the noise in the individual image to be improved. Thus, a noise-reduced individual image is provided (e.g., generated) based on the at least one synthetic prediction individual image and the individual image to be improved. The reducing algorithm may optionally also include a model based on machine learning, though it does not have to. The reducing algorithm may be relatively simply configured. The noise-reduced individual image may be provided. For example, the task result may be provided as a stored file on a data carrier or as output via a user interface (e.g., on a display output device such as a screen and/or a monitor).

According to one embodiment, the application of the reducing algorithm includes that a (e.g., weighted) averaging of the at least one synthetic prediction individual image and of the individual image to be improved is performed in order, based on the averaging, to provide (e.g., to generate) the noise-reduced individual image. An averaging represents a particularly simple and simultaneously effective possibility for generating the noise-reduced individual image. Compared with an averaging directly with the preceding individual images, the averaging with the at least one synthetic prediction individual image may be advantageous, for example, in that artifacts caused by the averaging may be reduced or entirely prevented. In one embodiment, with a weighted averaging, the influence of the at least one synthetic prediction individual image and/or possibly of the plurality of synthetic prediction individual images on the result may be set in a targeted manner. For example, it may be provided that the individual image to be improved is more strongly weighted than each of the at least one synthetic prediction individual images, and/or the individual image to be improved alone is at least as strongly weighted as all the synthetic prediction individual images together. For example, a weighting factor of the individual image to be improved may be at least 0.3 (e.g., at least 0.5).

According to one embodiment, at least two different synthetic prediction individual images are generated, for example, in each case via at least partially differently applied methods and/or via at least partially different prediction algorithms. For example, it may be provided to average the individual image to be improved with the at least two different synthetic prediction individual images. Different synthetic prediction individual images may have the advantage that via statistical averaging, errors such as image errors or suboptimal image quality of each individual prediction individual image impair the final result less severely, specifically the noise-reduced individual image. For example, different prediction algorithms may have different strengths and weaknesses, and the generation of different prediction individual images based on different prediction algorithms may enable profiting from the different strengths and compensating for different weaknesses, for example, if an averaging of the prediction individual images is provided, possibly together with the individual image to be improved.

According to one embodiment, the at least two different synthetic prediction individual images differ at least in that they have a different noise. The noise may optionally be added artificially to the synthetic prediction individual images (e.g., as described here). Alternatively, the at least two different synthetic prediction individual images are generated directly with different noise. The noise may be random or pseudo-random in each case. For example, the noise of the at least two different synthetic prediction individual images may thus differ in a respective random noise distribution. Optionally, a strength of the noise from at least two of the at least two different synthetic prediction individual images may differ. For example, 2 to 30 (e.g., 3 to 20 or 5 to 15) synthetic prediction individual images, each with different noise, may be provided. In one embodiment, the signal-to-noise ratio may be improved overall by averaging the synthetic prediction individual images and the individual image to be improved.

According to one embodiment, a comparison algorithm is applied to the at least two different synthetic prediction individual images, which selects for further processing at least one of the at least two different synthetic prediction individual images so that the reducing algorithm is applied to the remainder of the at least two different synthetic prediction individual images (e.g., a single remaining one of the at least two different synthetic prediction individual images). In one embodiment, for example, it may therefore be determined which prediction individual images are best suited for the further procedure, while less well successful prediction individual images are rejected. For example, differently generated prediction individual images may each be differently well suited to respective different scanning situations and/or for scans of respective different objects (e.g., different organs). With the comparison algorithm, it may therefore be provided that, in each case, at least one prediction individual image that is as suitable as possible is used. The application of the comparison algorithm may include, for example, a comparison of the at least two different synthetic prediction individual images with the individual image to be improved. For example, a comparison with the individual image to be improved may include a comparison of the structures. Thus, for example, at least one synthetic prediction individual image may be picked out that predicts and/or estimates as well as possible the real situation measured with the individual image to be improved. In addition or alternatively, particular exclusion criteria may be provided. Predetermined exclusion criteria may include, for example, detected predefined image artifacts and/or types of image artifacts in the respective prediction individual image. Optionally, the reducing algorithm may include a trained model based on machine learning. The model may be trained, for example, with good and poor images sought out in advance. For example, the poor images may contain image artifacts. For example, the poor images may contain image artifacts or a faulty image prediction.

According to one embodiment, the prediction algorithm is configured to predict the at least one synthetic individual image with a low noise level or without noise so that a noise level of the predicted synthetic individual image is lower than a noise level of the individual image to be improved that is typically to be expected. In one embodiment, for example, the lower noise level of the synthetic individual image may be used to reduce the noise level of the individual image to be improved. In order to generate the synthetic individual image with a lower noise level, use may be made of the fact that via each of the preceding individual images, items of systematic structural information that enable information regarding the expected signal at the time point of the individual image to be improved may be included. Although the preceding individual images may also individually have a similar noise level to the individual image to be improved, this (e.g., in each case, randomly distributed) noise, however, may be lessened by the bringing together of information from a plurality of preceding individual images in the synthetic individual image.

According to one embodiment, the at least one synthetic prediction individual image is generated in that at least one noise is added to a generated synthetic individual image and/or wherein at least two different synthetic prediction individual images based on a single generated synthetic individual image are generated in that a different noise is added to each synthetic individual image. The added noise may be, for example, random or pseudo-random. For example, the noise may be an artificially generated noise such as a Gaussian noise or a noise taken from another scan. Optionally, the noise may be generated, for different synthetic individual images, each with different methods for adding noise. For example, it may be provided that the two different synthetic prediction individual images are averaged with different noise together with the individual image to be improved (e.g., weighted) in order to generate the noise-reduced individual image. This may be a simple possibility for reducing the noise in the individual image to be improved by averaging over different noise-laden images.

According to one embodiment, the prediction algorithm is specifically configured to predict a synthetic individual image of a specific type of organ and/or a specific type of body portion (e.g., of the examination object or of any examination object). For example, the trained model based on machine learning is trained with training data including image data of the specific type of organ and/or the specific type of body portion. In one embodiment, the prediction algorithm may thus be particularly well suited to predicting the synthetic individual image particularly accurately. It may be provided for different types of organs and/or types of body portions, in each case, to provide a specially configured prediction algorithm (e.g., a specific trained model). For example, it may be provided that a user may select which organ and/or which body portion is examined so that the corresponding prediction algorithm and/or the corresponding trained model is applied. Alternatively or additionally, an automatic recognition, for example, using a recognition algorithm, a respective organ and/or a body portion in at least one individual image of the sequence of images may be provided so that the respective specifically configured prediction algorithm and/or the respective specifically trained model is applied automatically.

According to one embodiment, the prediction algorithm is specifically configured to predict a synthetic individual image of a specific type of organ and/or of a specific type of body portion of the examination object (e.g., patient from which the sequence of images has just been recorded). For example, the trained model based on machine learning is trained with training data including at least a sequence of images of a, for example, X-ray-based, sequential (e.g., continuous) image recording (e.g., a fluoroscopy recording of the patient). For example, it may be provided to fine-tune the trained model specifically for a patient as soon as first image recordings of the patient to be used as training data are available. This provides the possibility of finely setting the trained model for the individual patient. The fine-tuned model may then be used for a further image recording from the patient. In one embodiment, therefore, it may be possible to predict a synthetic prediction image particularly well. For example, the prediction algorithm and/or the trained model may thus be adapted particularly well to individual movement patterns that occur with a specific patient. In one embodiment, therefore, the image quality may be improved in subsequent scans of the same patient, and/or a radiation burden may be reduced in that a radiation dose is reduced, since the noise may be better reduced.

According to one embodiment, a guided filter is used to generate the at least one synthetic prediction individual image, where, for example, the individual image to be improved is used as a mask image for the guided filter. With a guided filter, it is possible to achieve that less false information (e.g., substantially no false information) enters the synthetic image and/or that the synthetic individual image predicts particularly well an actual scan at the respective time point of the scan of the individual image to be improved. The principles of the application of a guided filter are described in a somewhat different context by Kaiming He et al. in “Guided Image Filtering”, IEEE Transactions on Pattern Analysis and Machine Intelligence, vol. 35, no. 6, pp. 1397-1409, June 2013, doi: 10.1109/TPAMI.2012.213.

According to one embodiment, additional input information from a further scan is input into the prediction algorithm. The prediction algorithm is configured to predict the synthetic individual image additionally based on the additional input information. The additional input information may include, for example, one or more of the following information items relating to a patient from which the sequence of images originates: an ECG signal, a breathing signal, optically generated information. An ECG (electrocardiogram) signal, a breathing signal, or optically generated information may be generated particularly easily. In one embodiment, the additional input information may be used, for example, to obtain more exact information regarding a movement of the respectively observed organ or the respectively observed body region and thus to improve further the estimation of the synthetic individual image. An ECG signal may provide information regarding heart activity. A breathing signal may be used better to estimate movements in the torso region and/or abdomen region. A breathing signal may be determined, for example, with the aid of a marker (e.g., an optical marker that is placed on a patient and is acquired via an acquisition unit, such as an optical acquisition unit such as a camera, specifically an infrared camera). Optically generated information may include, for example, optical image data and/or information from an image-based movement model.

A further aspect of the present embodiments is a computer-implemented method for recording and displaying a temporal sequence of images of a, for example, X-ray-based sequential image recording of individual images that map an at least partially common examination region of an examination object, including the following acts: sequential acquisition of individual images at least partially of an examination region of an examination object in each case as the sequence of images in the context of the sequential image recording with a, for example, X-ray-based imaging device; applying the method for reducing a noise as described herein in order to reduce a noise in respective current individual images as individual images to be improved, making use of previously recorded preceding individual images so that during the recording, a sequence of noise-reduced individual images is generated; displaying the sequence of noise-reduced individual images on an output device.

The sequential image recording may be, for example, a continuous image recording (e.g., a fluoroscopic recording). A sequential acquisition of individual images may be a temporally sequential acquisition of the individual images. The sequential acquisition of individual images may be, for example, a continuous acquisition of individual images. The X-ray-based imaging device may be, for example, a fluoroscope.

According to one embodiment, the acquired sequence of individual images is used to fine-tune the trained model, where in each case, sets of preceding individual images are used, each together with a subsequent individual image to be improved, as training pairs. Optionally, it may be provided that the trained model is trained specifically for an examination object (e.g., for a patient that the sequence of images at least partially maps), so that an adapted trained model is provided that is specifically adapted to a recording of the examination object. The method may be carried out, for example, in a subsequent recording of the patient with the adapted trained model. For example, the trained model may be trained specifically for a specific type of organ and/or a specific type of body portion of the patient.

A further aspect of the present embodiments includes a computer-implemented method for providing a trained model, including: receiving training data that includes at least one temporal sequence of images of a, for example, X-ray-based sequential (e.g., continuous) image recording (e.g., a fluoroscopy recording) of individual images that map an at least partially common examination region of an examination object; assembling training pairs, each including a set of preceding individual images of one of the at least one sequence of images as part of input training data with a subsequent individual image of the one of the at least one sequence of images as part of output training data, where the subsequent individual image is or will be configured (e.g., processed), such that it has a reduced noise level; training the model based on machine learning with the training pairs; and providing the trained model.

In one embodiment, the training data may be based on previously recorded sequential (e.g., continuous) image recordings. Output training data, also designated ground truth, may be generated easily based on the respective next and/or subsequent individual image after a series of images. A reduced noise in the subsequent individual image may be achieved via a conventional method for noise reduction known in the prior art. In one embodiment, this method for noise reduction that is used may also be more computation-intensive since the noise reduction for the training data does not have to take place in quasi-real time. For example, a known method for noise reduction as described by Hariharan et al. in “Robust learning-based x-ray image denoising-potential pitfalls, their analysis and solutions,” Biomed. Phys. Eng. Express 8 (2022) 035013, or by Hariharan et al. in “An analytical approach for the simulation of realistic low-dose fluoroscopic images,” International Journal of Computer Assisted Radiology and Surgery (2019) 14:601-610 may be used. Optionally, a noise reduction may be achieved in that a subsequent individual image is averaged together with further individual images that show substantially the same thing. It may possibly also be an option to obtain the subsequent individual image in that an increased radiation dose is applied, and therefore, a better signal-to-noise ratio is achieved. Optionally, the training may include training specifically for a particular organ and/or a particular body region (e.g., head, heart, abdomen, lung). For example, the model may initially be generally trained and then fine-tuned specifically for a particular organ and/or a particular body region. In addition or alternatively, a fine-tuning may be provided for a specific patient and/or a specific organ and/or a specific body region of a specific patient (e.g., as described herein). For the training, for example, 100 to 100,000 (e.g., 1000 to 10,000) training pairs may be provided. In one embodiment, the training data is based on images of at least 50 (e.g., at least 80 or at least 100) different patients. In one embodiment, the training data originates from patients of different sex and age, for example, such that the most general possible representation of different age levels of each sex is provided. Via the use of sufficiently many different patients, it may be provided that the trained model is applicable as generally as possible.

A further aspect of the present embodiments is a provision unit that is configured to carry out a proposed computer-implemented method for reducing a noise in an individual image to be improved and/or a computer-implemented method for recording and displaying a temporal sequence of images of a sequential image recording of individual images. All the advantages and features of the computer-implemented method for reducing a noise in an individual image to be improved and/or a computer-implemented method for recording and displaying a temporal sequence of images of a sequential image recording of individual images may likewise be transferred to the provision unit and vice versa.

The provision unit may include a computing unit, a memory storage unit, and/or an interface. The provision unit (e.g., the components of the provision unit, including one or more processors) may be configured for carrying out the individual acts of the computer-implemented method of the present embodiments for reducing a noise in an individual image to be improved and/or of the proposed computer-implemented method for recording and displaying a temporal sequence of images of a sequential image recording of individual images.

The present embodiments may further relate to a training unit that is configured to carry out a proposed computer-implemented method for providing a trained model. Therein, the training unit may include a training interface, a training storage unit, and/or a training computing unit. The training unit may be configured to carry out a method for providing a trained model in that the training interface, the training storage unit, and/or the training computing unit may be configured to carry out the corresponding method acts.

All the advantages and features of the computer-implemented method for providing a trained model may be transferred likewise to the training unit and vice versa.

A further aspect of the present embodiments is a computer program product or a computer-readable storage medium (e.g., a non-volatile storage medium), including commands that, on their execution by a computer unit or a computer system (e.g., via at least one evaluating device and/or a control device of an X-ray-based imaging device, such as a fluoroscope, cause them/it to carry out the acts of one of the methods described herein. The computer program product may be stored, for example, on a computer-readable storage medium (e.g., a non-volatile storage medium). The storage medium may be, for example, a hard disk drive, an SSD, a flash storage unit, an online server, etc.

A further aspect of the present embodiments is a, for example, X-ray-based imaging system. The imaging system includes the following: at least one imaging device for sequential (e.g., continuous) acquisition of image data; at least one evaluating device with an interface for receiving sequences of images based on the image data and with a provision unit as described herein in order to provide a sequence of noise-reduced individual images; a display device with an interface to the at least one evaluating device, for display of the sequence of noise-reduced individual images. The imaging system is configured, for example, to carry out one of the methods as described herein. The at least one imaging device may be, for example, an X-ray-based imaging device and/or an X-ray source and at least one X-ray detector. The imaging device may be configured for sequential acquisition of image data. The imaging device may be or include, for example, a fluoroscope. The expression X-ray source is to be understood broadly in the context of the present embodiments. It relates, in general, to a device suitable for generating X-rays. The X-ray source may be an X-ray source for deployment and/or for use in a fluoroscope. An X-ray detector is, in general, a detector suitable for acquiring X-ray radiation. The X-ray detector may be a, for example, digital flat-panel detector. For example, the X-ray detector may include an X-ray sensitive material that is configured for detecting the X-ray radiation. For example, the X-ray detector may include a scintillation material and/or a scintillation counter for detecting the X-ray radiation.

All the embodiments described herein may be combined with one another if not explicitly stated otherwise.

### BRIEF DESCRIPTION OF THE DRAWINGS

Embodiments will now be described making reference to the accompanying drawings.

FIG. 1 shows a flow diagram of a computer-implemented method for reducing a noise in an individual image to be improved of a temporal sequence of images, according to an embodiment;

FIG. 2 shows a flow diagram of a computer-implemented method for reducing a noise in an individual image to be improved of a temporal sequence of images, according to a further embodiment;

FIG. 3 shows a flow diagram of a computer-implemented method for reducing a noise in an individual image to be improved of a temporal sequence of images, according to a further embodiment;

FIG. 4 shows a diagram illustrating an aspect of the computer-implemented method for reducing a noise in an individual image to be improved of a temporal sequence of images, according to an embodiment;

FIG. 5 shows a flow diagram of a computer-implemented method for recording and displaying a temporal sequence of images, according to an embodiment;

FIG. 6 shows a flow diagram of a computer-implemented method for providing a trained model according to an embodiment; and

FIG. 7 shows an X-ray-based imaging system including a fluoroscope with an X-ray source and an X-ray detector for sequential acquisition of image data according to an embodiment.

### DETAILED DESCRIPTION

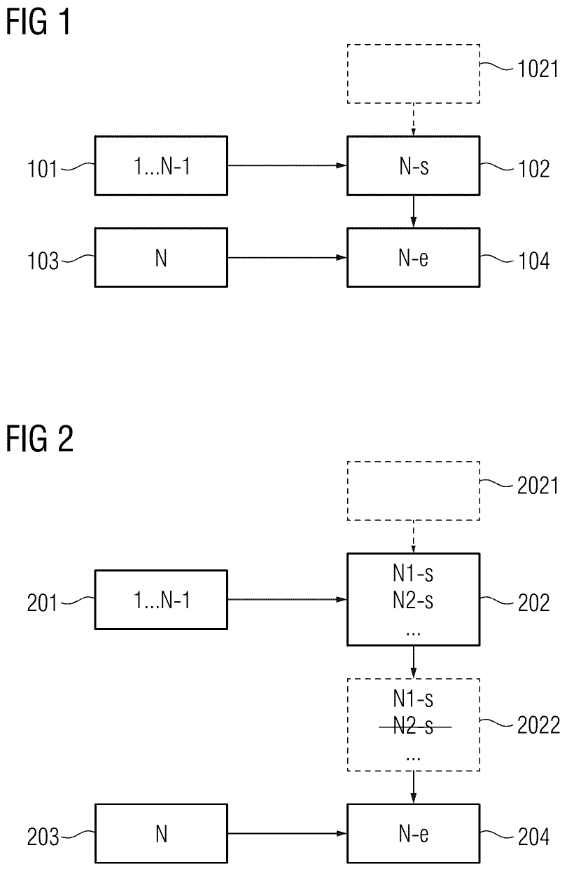

FIG. 1 shows a flow diagram of a computer-implemented method for reducing a noise in an individual image to be improved of a temporal sequence of images of a, for example, X-ray-based sequential image recording (e.g., a fluoroscopy recording) according to one embodiment. In a first act 101, a series of preceding individual images (in this example, the images 1 to N-1) that have been recorded temporally before the individual image to be improved (in this example, the subsequent image, number N) and are a portion of the sequence of images is received. In a further act 102, a prediction algorithm is applied to the series of preceding individual images so that a synthetic prediction individual image (in this example, the synthetic image N-s) is generated. In one embodiment, the prediction algorithm includes a model based on machine learning that is trained, based on a series of preceding individual images, to predict at least one synthetic individual image for a time point of the recording of the individual image to be improved. Optionally, the prediction algorithm may be configured to predict the synthetic individual image with a low noise level or without noise so that a noise level of the predicted synthetic individual image is lower than a noise level of the individual image to be improved that is typically to be expected. Optionally, the prediction algorithm may specifically be configured to predict a synthetic individual image of a specific type of organ and/or a specific type of body portion of the examination object. For example, the trained model based on machine learning may be trained with training data including image data of the specific type of organ and/or the specific type of body portion. In an optional act 1021, additional input information from a further scan may be input into the prediction algorithm. In this case, the prediction algorithm is configured, for example, to predict the synthetic individual image additionally based on the additional input information. The additional input information may be, for example, an ECG signal, a breathing signal, and/or optically generated information regarding a patient from whom the sequence of images originates. In a further act 103, the individual image to be improved is received. The individual image to be improved may optionally be received substantially simultaneously with the preceding individual images. Alternatively, the individual image to be improved may be received after the preceding individual images. For example, each of the individual images may be received directly after its recording. Finally, in yet another act 104, a reducing algorithm is applied to the individual image to be improved and the synthetic prediction individual image in order to reduce the noise in the individual image to be improved and to provide a noise-reduced individual image (in this example, N-e) based on the synthetic prediction individual image and the individual image to be improved. The application of the reducing algorithm may include, for example, that a weighted averaging of the synthetic prediction individual image and of the individual image to be improved is performed in order, based on the averaging, to provide the noise-reduced individual image.

FIG. 2 shows a flow diagram of a computer-implemented method for reducing a noise in an individual image to be improved of a temporal sequence of images of a, for example, X-ray-based sequential image recording (e.g., a fluoroscopy recording) according to a further embodiment. In a first act 201, a series of preceding individual images (in this example, the images 1 to N-1) that have been recorded temporally before the individual image to be improved (in this example, the subsequent image, number N) and are a portion of the sequence of images is received. In a further act 202, a prediction algorithm is applied to the series of preceding individual images so that a plurality of synthetic prediction individual images (in this example, the synthetic images N1-s, N2-s, etc.) is generated. In one embodiment, the prediction algorithm includes a model based on machine learning that is trained based on a series of preceding individual images, to predict at least one synthetic individual image for a time point of the recording of the individual image to be improved. It may be provided that a plurality of different models or, in general, different algorithms generate the different synthetic prediction individual images. Optionally, the model may be trained to predict a plurality of synthetic individual images directly. Alternatively, the model may be trained to predict a single synthetic individual image and then, based on the single synthetic individual image, a plurality of different individual images is generated via a further algorithm. Optionally, the prediction algorithm may be configured to predict the one synthetic individual image and/or the plurality of synthetic individual images with a low noise level or without noise so that a noise level of the predicted synthetic individual image and/or the synthetic individual images is lower than a noise level of the individual image to be improved that is typically to be expected. Similarly to the embodiment in FIG. 1, the prediction algorithm may optionally specifically be configured to predict the synthetic individual images of a specific type of organ and/or a specific type of body portion of the examination object. In an optional act 2021, similarly to the embodiment in FIG. 1, additional input information from a further scan may be input into the prediction algorithm. In a further act 203, the individual image to be improved is received. The individual image to be improved may optionally be received substantially simultaneously with the preceding individual images. Alternatively, the individual image to be improved may be received after the preceding individual images. For example, each of the individual images may be received directly after its recording. Optionally, in a further act 2022, a comparison algorithm may be applied to the different synthetic prediction individual images. The comparison algorithm sorts out for further processing at least one (in this example, the image N2-s) of the synthetic prediction individual images so that, in the following act, the reducing algorithm is applied to the remainder of the different synthetic prediction individual images (e.g., optionally, a single remaining one of the different synthetic prediction individual images). The application of the comparison algorithm may include, for example, a comparison of the at least two different synthetic prediction individual images with the individual image to be improved. In a further act 204, a reducing algorithm is applied to the individual image to be improved and to the synthetic prediction individual images and/or to the at least one remaining synthetic prediction individual image in order to reduce the noise in the individual image to be improved and to provide a noise-reduced individual image (in this example, N-e) based on the synthetic prediction individual images and/or of the at least one remaining synthetic prediction individual image and the individual image to be improved. The application of the reducing algorithm may include, for example, that a weighted averaging of the at least one synthetic prediction individual image and of the individual image to be improved is performed in order, based on the averaging, to provide the noise-reduced individual image.

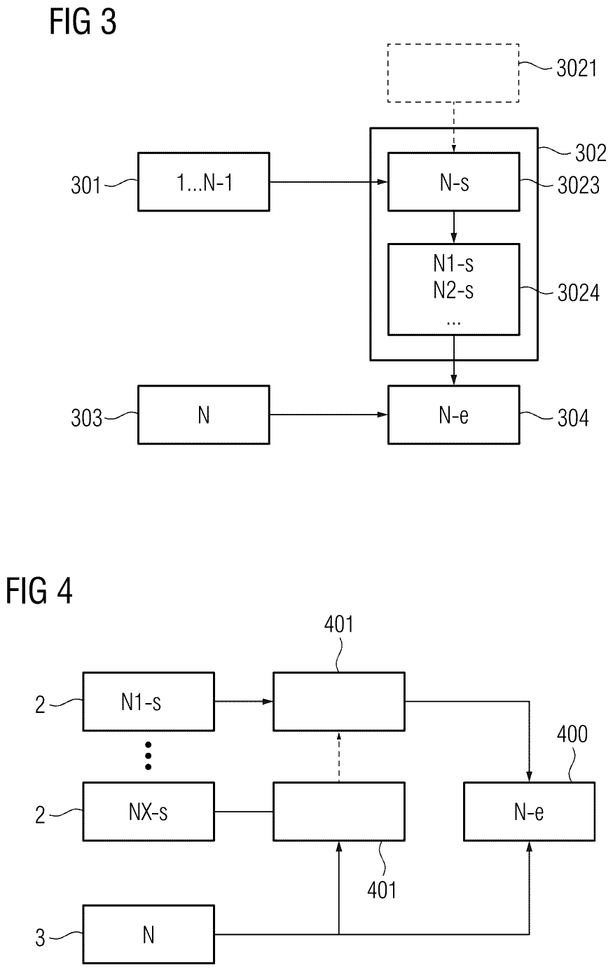

FIG. 3 shows a flow diagram of a computer-implemented method for reducing a noise in an individual image to be improved of a temporal sequence of images of a, for example, X-ray-based sequential image recording (e.g., a fluoroscopy recording) according to a further embodiment. In a first act 301, a series of preceding individual images (in this example, the images 1 to N-1) that have been recorded temporally before the individual image to be improved (in this example, the subsequent image, number N) and are a portion of the sequence of images, is received. In a further act 302, a plurality of synthetic prediction individual images (in this example, the synthetic images N1-s, N2-s, etc.) is generated. For this purpose, in a first substep 3023, initially, a synthetic individual image with a low noise level or without noise is predicted so that a noise level of the predicted synthetic individual image is lower than a noise level of the individual image to be improved that is typically to be expected. For this purpose, a trained model based on machine learning may be used. Similarly to the embodiment in FIG. 1, the prediction algorithm (e.g., the trained model) may optionally specifically be configured (e.g., trained) to predict the synthetic individual images of a specific type of organ and/or of a specific type of body portion. In an optional act 3021, similarly to the embodiment in FIG. 1, additional input information from a further scan may be input into the prediction algorithm in order also to use it for the prediction of the synthetic individual image. This additional input information may optionally be provided as further input for the trained model. In a further substep 3024, a plurality of different synthetic prediction individual images (e.g., N1-s, N2-s, etc.) is generated based on the single generated synthetic individual image in that a different noise is added to each synthetic individual image. The different synthetic prediction individual images therefore differ in that the different synthetic prediction individual images have a different noise. In a further act 303, the individual image to be improved is received. The individual image to be improved may optionally be received substantially simultaneously with the preceding individual images. Alternatively, the individual image to be improved may be received after the preceding individual images. For example, each of the individual images may be received directly after its recording. In a further act 304, a reducing algorithm is applied to the individual image to be improved and to the synthetic prediction individual images and/or to the at least one remaining synthetic prediction individual image, in order to reduce the noise in the individual image to be improved and to provide a noise-reduced individual image (in this example, N-e) based on the synthetic prediction individual images and/or of the at least one remaining synthetic prediction individual image and the individual image to be improved. The application of the reducing algorithm may include, for example, that a weighted averaging of the at least one synthetic prediction individual image and of the individual image to be improved is performed in order, based on the averaging, to provide the noise-reduced individual image.

FIG. 4 shows a diagram illustrating an aspect of the computer-implemented method for reducing a noise in an individual image 3 that is to be improved of a temporal sequence of images of a, for example, X-ray-based sequential image recording (e.g., a fluoroscopy recording) according to one embodiment. First, preceding individual images of the sequence of images are recorded and then used in order to generate, with a trained model based on machine learning (e.g., based on a CNN, vision transformers, a diffusion model, or a GAN), a plurality of synthetic prediction individual images 2. Then, the individual image 3 to be improved is recorded. A guided filter 401 is applied to the synthetic prediction individual images 2, where the individual image 3 to be improved is used as a mask image for the guided filter. Finally, a weighted averaging 400 is performed, in which the filtered synthetic prediction individual images 2 are averaged with weighting, together with the individual image 3 to be improved in order to generate a noise-reduced individual image. In the weighted averaging 400, the weighting of the individual image 3 to be improved may be at least 50%.

FIG. 5 shows a flow diagram of a computer-implemented method for recording and displaying a temporal sequence of images of a, for example, X-ray-based sequential image recording (e.g., a fluoroscopy recording), according to one embodiment. In a first act 500, individual images are acquired sequentially (e.g., continuously) as the sequence of images in the context of the sequential image recording with a, for example, X-ray-based imaging device (e.g., a fluoroscope 10). The sequence of images includes an individual image 3 to be improved and a series of preceding individual images that have been recorded temporally before the individual image 3 to be improved. This act may be carried out partially simultaneously with some of the further acts. For example, the preceding individual images may optionally already be processed while the individual image 3 to be improved is still being recorded. In a further act 501, the series of preceding individual images is received by a program for denoising the individual image 3 to be improved. In a further act 502, a prediction algorithm including a trained model based on machine learning is applied to the series of preceding individual images so that at least one synthetic prediction individual image 2 is provided. In a further act 503, the individual image 3 to be improved is received by the program. In a further act 504, a reducing algorithm is applied to the individual image 3 to be improved and to the at least one synthetic prediction individual image 2 in order to reduce the noise in the individual image 3 to be improved and to provide a noise-reduced individual image based on the at least one synthetic prediction individual image 2 and of the individual image 3 to be improved. Acts 501 to 504 may be provided similarly to the acts of the method described in relation to FIGS. 1 to 4 and possibly extended with acts shown therein. In a further act 505, the sequence of noise-reduced individual images is displayed on an output device (e.g., on a screen). Optionally, in a further act 510, it may be provided to use the acquired sequence of individual images in order to fine-tune the trained model, where in each case, sets of preceding individual images are used, each together with a subsequent individual image 3 to be improved, as training pairs. The trained model may optionally be fine-tuned specifically for a patient from whom the sequence of images was recorded, so that an adapted trained model is generated specifically adapted to a recording of the patient. The method described may then be carried out in a further subsequent recording of the patient with the adapted trained model.

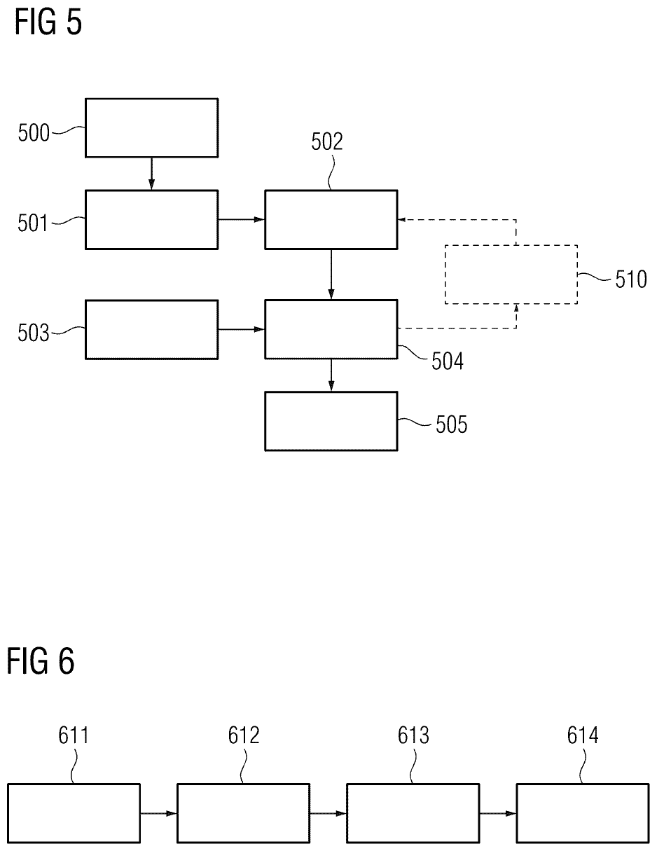

FIG. 6 shows a flow diagram of a computer-implemented method for providing a trained model according to one embodiment. In a first act 611, training data is received, where the training data includes at least one sequence of images of a, for example, X-ray-based sequential image recording (e.g., a fluoroscopy recording). In a further act 612, training pairs are assembled, each including a set of preceding individual images of one of the at least one sequence of images as part of input training data with a subsequent individual image of the one of the at least one sequence of images as part of output training data. Therein, the subsequent individual image may be configured and/or processed, for example, such that the subsequent individual image has a reduced noise level. In a further act 613, the model is trained based on machine learning with the training pairs. Finally, the now trained model is provided in a further act 614.

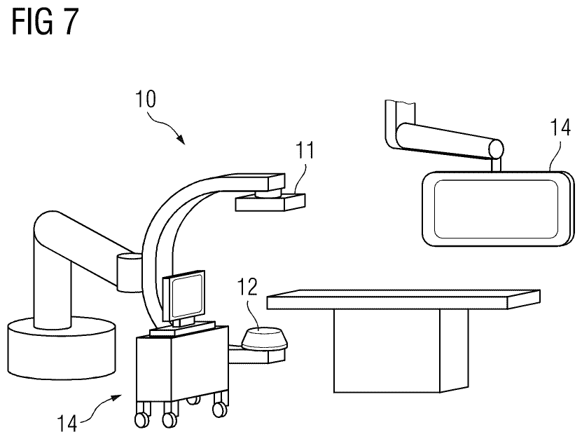

FIG. 7 shows an X-ray-based imaging system including a fluoroscope 10 with an X-ray source 12 and an X-ray detector 11 for sequential acquisition of image data according to one embodiment. The imaging system includes an evaluating device 14 with an interface for receiving sequences of images based on the image data and a provision unit. The evaluating device and/or the provision unit is configured to perform the method according to the present embodiments, as described in relation to one of FIGS. 1 to 4 in order to provide a sequence of noise-reduced individual images. The sequence of noise-reduced individual images may be displayed on a display unit 14.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for reducing a noise in an individual image that is to be improved of a temporal sequence of images of a sequential image recording of individual images that map an at least partially common examination region of an examination object, the method being computer-implemented and comprising:
receiving a series of preceding individual images that have been recorded temporally before the individual image to be improved and that are a portion of the sequence of images;
applying a prediction algorithm to the series of preceding individual images, wherein the prediction algorithm is configured to predict, based on a series of preceding individual images, at least one synthetic individual image for a time point of the recording of the individual image to be improved, and wherein the prediction algorithm provides at least one synthetic prediction individual image as output data;
receiving the individual image to be improved; and
applying a reducing algorithm to the individual image to be improved and to the at least one synthetic prediction individual image, such that a noise-reduced individual image is provided based on the at least one synthetic prediction individual image and the individual image to be improved.

2. The method of claim 1, wherein the application of the reducing algorithm comprises that a weighted averaging of the at least one synthetic prediction individual image and of the individual image to be improved is performed in order, based on the averaging, to provide the noise-reduced individual image.

3. The method of claim 1, wherein at least two different synthetic prediction individual images are generated in each case via at least partially differently applied methods, via at least partially different prediction algorithms, or via the at least partially differently applied methods and the at least partially different prediction algorithms.

4. The method of claim 3, wherein the at least two different synthetic prediction individual images differ at least in that the at least two different synthetic prediction individual images have a different noise.

5. The method of claim 3, further comprising applying a comparison algorithm to the at least two different synthetic prediction individual images, the comparison algorithm sorting out at least one of the at least two different synthetic prediction individual images for further processing, so that the reducing algorithm is applied to the remainder of the at least two different synthetic prediction individual images,
wherein the applying of the comparison algorithm comprises a comparison of the at least two different synthetic prediction individual images with the individual image to be improved.

6. The method of claim 1, wherein the prediction algorithm is configured to predict the at least one synthetic individual image with a low noise level or without noise, so that a noise level of the predicted synthetic individual image is lower than a noise level of the individual image to be improved that is typically to be expected.

7. The method of claim 6, wherein:
the at least one synthetic prediction individual image is generated in that at least one noise is added to a generated synthetic individual image;
at least two different synthetic prediction individual images based on a single generated synthetic individual image are generated in that a different noise is added to each synthetic individual image; or
a combination thereof.

8. The method of claim 1, wherein the prediction algorithm is configured to predict a synthetic individual image of a specific type of organ, a specific type of body portion of the examination object or of any examination object, or the specific type of organ and the specific type of body portion, and
wherein the trained model based on machine learning is trained with training data comprising image data of the specific type of organ, the specific type of body portion, or the specific type of organ and the specific type of body portion.

9. The method of claim 1, wherein a guided filter is used to generate the at least one synthetic prediction individual image, and
wherein the individual image to be improved is used as a mask image for the guided filter.

10. The method of claim 1, wherein additional input information from a further scan is input into the prediction algorithm,
wherein the prediction algorithm is configured to predict the synthetic individual image additionally based on the additional input information, and
wherein the additional input information comprises one or more information items relating to a patient from which the sequence of images originates, the one or more information items comprising an ECG signal, a breathing signal, optically generated information, or any combination thereof.

11. The method of claim 1, wherein the prediction algorithm comprises a trained model based on machine learning.

12. A method for recording and displaying a temporal sequence of images of a sequential image recording of individual images that map an at least partially common examination region of an examination object, the method being computer-implemented and comprising:
sequential acquisition of individual images at least partially of an examination region of an examination object in each case as the sequence of images in the context of the sequential image recording with an imaging device;
applying a method for reducing a noise in respective current individual images as individual images to be improved, making use of previously recorded preceding individual images so that during the recording, a sequence of noise-reduced individual images is generated, the method for reducing the noise comprising:
receiving a series of preceding individual images that have been recorded temporally before the individual image to be improved and that are a portion of the sequence of images;
applying a prediction algorithm to the series of preceding individual images, wherein the prediction algorithm is configured to predict, based on a series of preceding individual images, at least one synthetic individual image for a time point of the recording of the individual image to be improved, and wherein the prediction algorithm provides at least one synthetic prediction individual image as output data;
receiving the individual image to be improved; and
applying a reducing algorithm to the individual image to be improved and to the at least one synthetic prediction individual image, such that a noise-reduced individual image is provided based on the at least one synthetic prediction individual image and the individual image to be improved; and
displaying the sequence of noise-reduced individual images on an output device.

13. The method of claim 12, wherein the prediction algorithm comprises a trained model based on machine learning,
wherein the method for reducing a noise is applied in order to reduce the noise in the respective current individual images as individual images to be improved, making use, in each case, of previously recorded preceding individual images,
wherein the acquired sequence of individual images is used in order to fine-tune the trained model,
wherein in each case, sets of preceding individual images are used, each together with a subsequent individual image to be improved, as training pairs, and
wherein the method is carried out in a subsequent recording of the examination object with the adapted trained model.

14. The method of claim 13, wherein the trained model is trained specifically for an examination object that the sequence of images at least partially maps, so that an adapted trained model is provided that is specifically adapted for a recording of the examination object.

15. A computer-implemented method for providing a trained model, the computer-implemented method comprising:
receiving training data, wherein the training data comprises at least one temporal sequence of images of a sequential image recording of individual images that map an at least partially common examination region of an examination object;
assembling training pairs, each of the training pairs comprising a set of preceding individual images of one of the at least one sequence of images as part of input training data with a subsequent individual image of the one of the at least one sequence of images as part of output training data, wherein the subsequent individual image is or will be configured, processed, or configured and processed, such that the subsequent individual image has a reduced noise level;
training the model based on machine learning with the training pairs; and
providing the trained model.

16. A provision unit comprising:
a processor configured to reduce a noise in an individual image that is to be improved of a temporal sequence of images of a sequential image recording of individual images that map an at least partially common examination region of an examination object, the processor being configured to reduce the noise comprising the processor being configured to:
receive a series of preceding individual images that have been recorded temporally before the individual image to be improved and that are a portion of the sequence of images;
apply a prediction algorithm to the series of preceding individual images, wherein the prediction algorithm is configured to predict, based on a series of preceding individual images, at least one synthetic individual image for a time point of the recording of the individual image to be improved, and wherein the prediction algorithm provides at least one synthetic prediction individual image as output data;
receive the individual image to be improved; and
apply a reducing algorithm to the individual image to be improved and to the at least one synthetic prediction individual image, such that a noise-reduced individual image is provided based on the at least one synthetic prediction individual image and the individual image to be improved.

17. (canceled)

18. (canceled)
